(19) United States
(12) Patent Application Publication
(10) Pub. No.: US 2018/0354192 A1
(43) Pub. Date: Dec. 13, 2018

(54) THREE-DIMENSIONAL PRINTING APPARATUS

(71) Applicant: Roland DG Corporation, Hamamatsu-shi (JP)

(72) Inventors: Fumiyoshi IWASE, Hamamatsu-shi (JP); Takafumi TAKANO, Hamamatsu-shi (JP)

(21) Appl. No.: 15/997,850

(22) Filed: Jun. 5, 2018

(30) Foreign Application Priority Data
Jun. 13, 2017 (JP) 2017-115583

(51) Int. Cl. B29C 64/165; B29C 64/35; B29C 64/245; B29C 64/255; B29C 64/209; B29C 64/295

(52) U.S. Cl. CPC B29C 64/165; B29C 64/35; B29C 64/245; B33Y 30/00; B29C 64/209; B29C 64/295; B29C 64/255

(57) ABSTRACT

A three-dimensional printing apparatus includes a holder, a printing tank, a printing table, a line head, a conveyor, and a medium placement stage. The holder holds a three-dimensional object that has been printed. The tank is disposed in the holder and stores a powder material. The table is disposed in a printing space of the tank. The powder material is placed on the table. The line head includes nozzles disposed in a straight line in a right-left direction. The conveyor moves the holder relative to the line head in a scanning direction. The stage is disposed on a portion of the holder downstream of the table in the scanning direction and is parallel or substantially parallel to the table in the right-left direction. A medium to undergo test pattern printing effected by the line head is placed on the stage.

### CROSS REFERENCE TO RELATED APPLICATIONS

This application claims the benefit of priority to Japanese Patent Application No. 2017-115583 filed on Jun. 13, 2017. The entire contents of this application are hereby incorporated herein by reference.

### BACKGROUND OF THE INVENTION

### 1. Field of the Invention

The present invention relates to three-dimensional printing apparatuses.

### 2. Description of the Related Art

As disclosed in Japanese Patent No. 5400042, an additive manufacturing method known in the related art involves discharging a binder onto a powder material and curing the powder material so as to print a desired three-dimensional object.

A three-dimensional printing apparatus disclosed in Japanese Patent No. 5400042 includes: a printing unit that holds powder; a powder feeder that stores powder to be fed to the printing unit; and an inkjet line head (hereinafter referred to as a “line head”) disposed above the printing unit. The line head discharges water-based ink onto the powder held in the printing unit. Specifically, the line head discharges water-based ink onto a portion of the powder that is held in the printing unit and corresponds to a cross-sectional shape of a three-dimensional object to be printed. The portion of the powder onto which the water-based ink is discharged is cured so as to form a cured layer conforming to the cross-sectional shape. Sequentially stacking such cured layers prints a desired three-dimensional object.

Printing a three-dimensional object by an additive manufacturing method may cause a powder material to adhere to a nozzle of a line head, resulting in clogging of the nozzle. To solve this problem, a three-dimensional printing apparatus may print a test pattern so as to determine the occurrence of nozzle clogging and/or may be provided with a maintenance device to perform maintenance so as to reduce or eliminate nozzle clogging. For example, printing a test pattern on a powder material, however, is not preferable because the powder material is wasted. To eliminate such waste, a predetermined recording medium may be placed on a powder material, and a test pattern may be printed on the recording medium. In such a case, however, the recording medium may be secured insufficiently, making it impossible to suitably print the test pattern.

### SUMMARY OF THE INVENTION

Accordingly, preferred embodiments of the present invention provide three-dimensional printing apparatuses each including a maintenance device to perform nozzle maintenance and/or a stage on which a medium to undergo test pattern printing is to be placed, with the maintenance device and/or the stage being disposed compactly in the three-dimensional printing apparatus.

A preferred embodiment of the present invention provides a three-dimensional printing apparatus to print a three-dimensional object by sequentially stacking cured layers each formed by curing a powder material. The three-dimensional printing apparatus includes a holder, a printing tank, a printing table, a line head, a conveyor, and a medium placement stage. The holder holds the three-dimensional object printed. The printing tank is disposed in the holder. The printing tank includes a printing space in which the powder material is to be held. The printing table is disposed in the printing space of the printing tank. The powder material is to be placed on the printing table. The line head includes a plurality of nozzles and a nozzle surface. The nozzles are disposed in a straight line in a first direction. The nozzles discharge a curing liquid onto the powder material placed on the printing table. The nozzle surface is provided with the nozzles. The conveyor moves one of the holder and the line head relative to the other one of the holder and the line head in a second direction perpendicular or substantially perpendicular to the first direction. The medium placement stage is disposed on a portion of the holder located on one side in the second direction relative to the printing table. The medium placement stage is disposed parallel or substantially parallel to the printing table in the first direction. A medium to undergo test pattern printing effected by the line head is to be placed on the medium placement stage.

The medium placement stage of the three-dimensional printing apparatus according to this preferred embodiment is disposed on the holder. More specifically, the medium placement stage is disposed on one side in the second direction relative to the printing table. The medium placement stage is disposed parallel or substantially parallel to the printing table in the first direction (e.g., in the first direction in the plan view). The nozzles of the line head are disposed in a straight line in the first direction, so that the length of the line head in the first direction is relatively long. Thus, if the medium placement stage is disposed laterally of the printing table (i.e., if the medium placement stage and the printing table are disposed parallel or substantially parallel each other in the second direction), the length of the three-dimensional printing apparatus in the first direction will be considerably long. This makes it necessary to provide a device to move the line head in the first direction, resulting in complicated structure of the three-dimensional printing apparatus. In this preferred embodiment, however, the medium placement stage is parallel or substantially parallel to the printing table in the first direction, so that the length of the three-dimensional printing apparatus increases only slightly in the second direction. The line head is required to be moved relative to the holder only in the second direction. Thus, the three-dimensional printing apparatus according to this preferred embodiment enables the medium placement stage to be disposed compactly. Consequently, the three-dimensional printing apparatus does not increase in size.

Another preferred embodiment of the present invention provides a three-dimensional printing apparatus to print a three-dimensional object by sequentially stacking cured layers each formed by curing a powder material. The three-dimensional printing apparatus includes a holder, a printing tank, a printing table, a line head, a conveyor, and a maintenance device. The holder holds the three-dimensional object printed. The printing tank is disposed in the holder. The printing tank includes a printing space in which the powder material is to be held. The printing table is disposed in the printing space of the printing tank. The powder material is to be placed on the printing table. The line head includes a plurality of nozzles and a nozzle surface. The nozzles are disposed in a straight line in a first direction. The nozzles discharge a curing liquid onto the powder material placed on the printing table. The nozzle surface is provided with the nozzles. The conveyor moves one of the holder and the line head relative to the other one of the holder and the line head in a second direction perpendicular or substantially perpendicular to the first direction. The maintenance device is disposed on a portion of the holder located on one side in the second direction relative to the printing table. The maintenance device is parallel or substantially parallel to the printing table in the first direction. The maintenance device performs maintenance of the nozzles.

The maintenance device of the three-dimensional printing apparatus according to this preferred embodiment is disposed on the holder. More specifically, the maintenance device is disposed on one side in the second direction relative to the printing table. The maintenance device is parallel or substantially parallel to the printing table in the first direction (e.g., in the first direction in the plan view). The nozzles of the line head are disposed in a straight line in the first direction, so that the length of the line head in the first direction is relatively long. Thus, if the maintenance device is disposed laterally of the printing table (i.e., if the maintenance device and the printing table are parallel or substantially parallel to each other in the second direction), the length of the three-dimensional printing apparatus in the first direction will be considerably long. This makes it necessary to provide a device to move the line head in the first direction, resulting in complicated structure of the three-dimensional printing apparatus. In this preferred embodiment, however, the maintenance device is parallel or substantially parallel to the printing table in the first direction, so that the length of the three-dimensional printing apparatus increases only slightly in the second direction. The line head is required to be moved relative to the holder only in the second direction. Thus, the three-dimensional printing apparatus according to this preferred embodiment enables the maintenance device to be disposed compactly. Consequently, the three-dimensional printing apparatus does not increase in size.

Various preferred embodiments of the present invention provide three-dimensional printing apparatuses each including a maintenance device to perform nozzle maintenance and/or a stage on which a medium to undergo test pattern printing is to be placed, with the maintenance device and/or the stage disposed compactly in the three-dimensional printing apparatus.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic cross-sectional view of a three-dimensional printing apparatus according to a preferred embodiment of the present invention, with a head unit located at a home position.

FIG. 2 is a schematic plan view of the three-dimensional printing apparatus according to the present preferred embodiment of the present invention.

FIG. 3 is a schematic cross-sectional view of the three-dimensional printing apparatus according to the present preferred embodiment of the present invention, with line heads located over a flushing stage.

FIG. 4 is a schematic plan view of the head unit and a portion of a holder.

FIG. 5 is a schematic cross-sectional view of the three-dimensional printing apparatus according to the present preferred embodiment of the present invention, with the line heads located over a medium placement stage.

FIG. 6 is a schematic cross-sectional view of the three-dimensional printing apparatus according to the present preferred embodiment of the present invention, with the line heads located over a printing tank.

### DETAILED DESCRIPTION OF THE PREFERRED EMBODIMENTS

Three-dimensional printing apparatuses according to preferred embodiments of the present invention will be described below with reference to the drawings. The preferred embodiments described below are naturally not intended to limit the present invention in any way. Components or elements having the same functions are identified by the same reference signs, and description thereof will be simplified or omitted when deemed redundant.

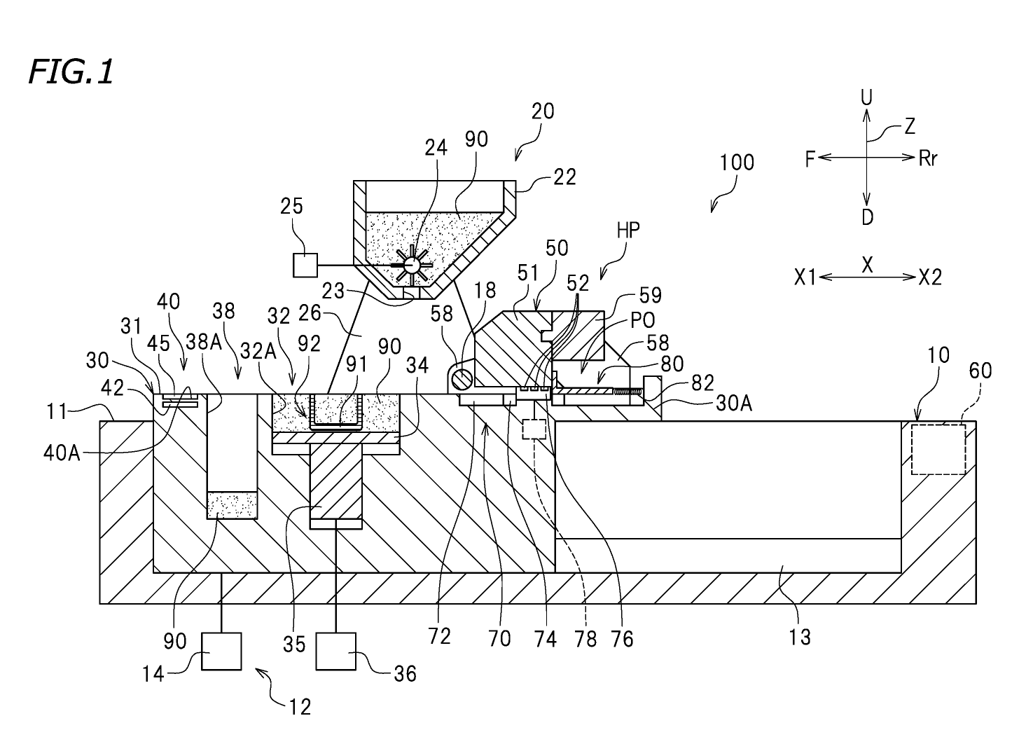

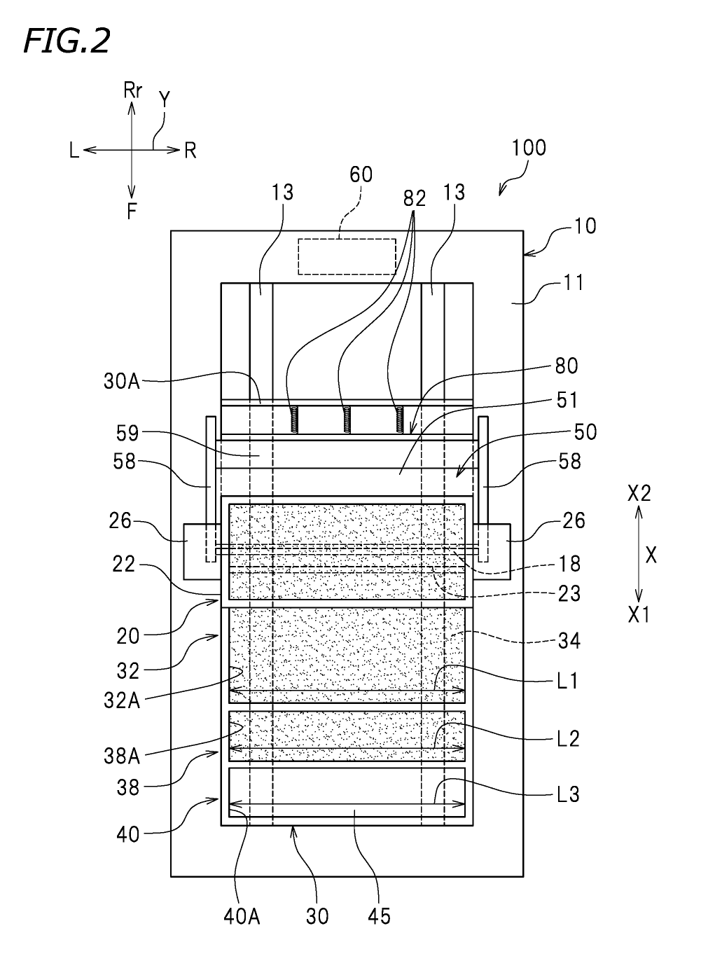

FIG. 1 is a cross-sectional view of the three-dimensional printing apparatus 100 according to the present preferred embodiment. FIG. 2 is a plan view of the three-dimensional printing apparatus 100 according to the present preferred embodiment. The reference sign F in the drawings represents front. The reference sign Rr in the drawings represents rear. The reference signs R, L, U, and D in the drawings respectively represent right, left, up, and down. As used herein, the terms “right”, “left”, “up”, and “down” respectively refer to right, left, up, and down with respect to an operator facing the front of the three-dimensional printing apparatus 100. In the present preferred embodiment, the reference signs X, Y, and Z respectively represent a front-rear direction, a right-left direction, and an up-down direction. The right-left direction Y corresponds to a “first direction”. The front-rear direction X may also be referred to as a “scanning direction X”. The front-rear direction X corresponds to a “second direction”. The up-down direction Z corresponds to a direction in which layers of a three-dimensional object are to be stacked. The rear side of the three-dimensional printing apparatus 100 may also be referred to as an “upstream side”. The front side of the three-dimensional printing apparatus 100 may also be referred to as a “downstream side”. In the present preferred embodiment, a direction from the upstream side to the downstream side will be referred to as an “onward direction X1”, and a direction from the downstream side to the upstream side will be referred to as a “backward direction X2”. These directions are defined merely for the sake of convenience of description and do not limit in any way how the three-dimensional printing apparatus 100 may be installed.

As illustrated in FIG. 1, the three-dimensional printing apparatus 100 cures a powder material 90 with a curing liquid so as to form cured layers 91. The three-dimensional printing apparatus 100 sequentially stacks the cured layers 91 in the up-down direction Z in such a manner that the cured layers 91 are integral with each other. Thus, the three-dimensional printing apparatus 100 prints a desired three-dimensional object 92. In accordance with a cross-sectional image indicative of a cross-sectional shape of the desired three-dimensional object 92, the three-dimensional printing apparatus 100 according to the present preferred embodiment discharges a curing liquid onto the powder material 90 so as to cure the powder material 90 and form the cured layer 91 conforming in shape to the cross-sectional image. The three-dimensional printing apparatus 100 sequentially stacks the cured layers 91 so as to print the desired three-dimensional object 92.

As used herein, the term “cross-sectional shape” refers to a cross-sectional shape obtained when the three-dimensional object 92 to be printed is cut into slices in a predetermined direction (e.g., a horizontal direction) such that each of the slices has a predetermined thickness (e.g., a thickness of about 0.1 mm). Each of the slices does not necessarily have to have a constant thickness.

As used herein, the term “powder material” refers to powder having any composition and shape. More specifically, the term “powder material” may refer to powder of various materials, such as a resin material, a metal material, and an inorganic material. Examples of components of the powder material 90 include: ceramic materials, such as alumina, silica, titania, and zirconia; metal materials, such as iron, aluminum, titanium, and an alloy thereof (which is typically stainless steel, a titanium alloy or an aluminum alloy); and other materials, such as gypsum hemihydrate (e.g., α type calcined gypsum and β type calcined gypsum), apatite, salt, and plastic. The powder material 90 may include any one of these components or may be a combination of two or more of these components.

As used herein, the term “curing liquid” refers to any liquid that causes particles of the powder material 90 to adhere to each other. Examples of the curing liquid to be used include a liquid that binds together particles of the powder material 90. The curing liquid may be a viscous substance. Examples of the curing liquid include a liquid containing water, wax, and/or a binder. When the powder material 90 contains a secondary component that is a water-soluble resin, a liquid that dissolves the water-soluble resin, such as water, may be used as the curing liquid. The water-soluble resin is not limited to any particular water-soluble resin. Examples of the water-soluble resin include starch, polyvinyl alcohol (PVA), polyvinyl pyrrolidone (PVP), water-soluble acrylic resin, water-soluble urethane resin, and water-soluble polyamide.

As illustrated in FIG. 1, the three-dimensional printing apparatus 100 includes a body 10, a conveyor 12, a spreading roller 18, a powder feeder 20, a holder 30, a head unit 50, and a controller 60.

As illustrated in FIG. 2, the body 10 is an outer body of the three-dimensional printing apparatus 100. The body 10 is elongated in the scanning direction X. The body 10 has a box shape that is open upward. The body 10 holds the conveyor 12 (see FIG. 1), the holder 30, and the controller 60. The body 10 also defines and functions as a support base supporting the spreading roller 18, the powder feeder 20, and the head unit 50.

As illustrated in FIG. 1, the holder 30 is held in the body 10. The holder 30 holds the three-dimensional object 92 that has been printed. The holder 30 includes a printing tank 32, a printing table 34, a raising and lowering device 36, an excess powder storage tank 38, a medium placement stage 40, and a maintenance device 70. The holder 30 includes a flat upper surface 31. The printing tank 32, the excess powder storage tank 38, and the medium placement stage 40 are recessed from the upper surface 31. The printing tank 32, the excess powder storage tank 38, and the medium placement stage 40 are arranged independently side by side.

As illustrated in FIG. 1, the printing tank 32 is provided in the holder 30. The printing tank 32 is a tank to store the powder material 90. The three-dimensional object 92 is to be printed in the printing tank 32. The printing tank 32 includes a printing space 32A in which the powder material 90 is to be held. The powder material 90 is fed to the printing space 32A so as to print the three-dimensional object 92 in the printing space 32A.

As illustrated in FIG. 1, the printing table 34 is disposed in the printing space 32A of the printing tank 32. The powder material 90 is placed on the printing table 34. The three-dimensional object 92 is printed in a portion of the printing space 32A located on the printing table 34. The printing table 34 is movable in the up-down direction Z. In one example, the printing table 34 has a rectangular shape in a plan view. The printing table 34 is provided with a table support 35. The table support 35 extends downward from the bottom surface of the printing table 34. The table support 35 is movable together with the printing table 34 in the up-down direction Z.

The raising and lowering device 36 is a device to move the printing table 34 in the up-down direction Z. In other words, the raising and lowering device 36 is a device to raise and lower the printing table 34. The raising and lowering device 36 is not limited to any particular configuration. In the present preferred embodiment, the raising and lowering device 36 includes a servomotor (not illustrated) and a ball screw (not illustrated). In one example, the servomotor is connected to the table support 35 and is connected to the printing table 34 through the table support 35. Driving the servomotor moves the table support 35 in the up-down direction Z. The movement of the table support 35 in the up-down direction Z moves the printing table 34 in the up-down direction Z. The raising and lowering device 36 is electrically connected to the controller 60. Thus, the raising and lowering device 36 is controlled by the controller 60.

When the powder material 90 fed to the printing tank 32 is spread through the printing tank 32 by the spreading roller 18, the excess powder storage tank 38 collects an excess portion of the powder material 90 that is not stored in the printing tank 32. The excess powder storage tank 38 includes a storing space 38A to store the excess portion of the powder material 90. The excess powder storage tank 38 is disposed in a portion of the holder 30 located between the printing tank 32 and the medium placement stage 40 in the scanning direction X. The excess powder storage tank 38 is disposed forward of the printing tank 32. The excess powder storage tank 38 is disposed rearward of the medium placement stage 40. The excess powder storage tank 38 is parallel or substantially parallel to the printing tank 32 in the right-left direction Y (e.g., in the right-left direction Y in the plan view). As illustrated in FIG. 2, in the plan view, a length L1 of the printing space 32A of the printing tank 32 in the right-left direction Y (i.e., a length of the printing table 34 in the right-left direction Y) is equal to a length L2 of the storing space 38A of the excess powder storage tank 38 in the right-left direction Y. Alternatively, the length L1 of the printing space 32A may be shorter than the length L2 of the storing space 38A.

The medium placement stage 40 is a stage on which a medium 45 is to be placed. Line heads 52 (which will be described below) of the head unit 50 print a test pattern on the medium 45. The medium placement stage 40 includes a placement region 40A where the medium 45 is to be placed. The medium placement stage 40 is disposed on a portion of the holder 30 forward of the printing table 34. In other words, the medium placement stage 40 is disposed on a portion of the holder 30 downstream of the printing table 34 in the scanning direction X, such that the medium placement stage 40 and the holder 30 are spaced from each other in the direction X. The medium placement stage 40 is parallel or substantially parallel to the printing table 34 in the right-left direction Y (e.g., in the right-left direction Y in the plan view). Although the medium placement stage 40 and the printing table 34 are parallel or substantially parallel to each other in the right-left direction Y, the left end of the medium placement stage 40 does not necessarily have to be in perfect parallel alignment (i.e., located along a same imaginary line extending in the direction X) with the left end of the printing table 34 in the right-left direction Y, and the right end of the medium placement stage 40 does not necessarily have to be in perfect parallel alignment (i.e., located along a same imaginary line extending in the direction X) with the right end of the printing table 34 in the right-left direction Y. A large portion of the medium placement stage 40 (e.g., a portion of the medium placement stage 40 along 80 percent or more of its length in the right-left direction Y) may be parallel or substantially parallel to a large portion of the printing table 34 (e.g., a portion of the printing table 34 along 80 percent or more of its length in the right-left direction Y) in the right-left direction Y. As illustrated in FIG. 2, in the plan view, the length L1 of the printing space 32A of the printing tank 32 in the right-left direction Y is equal to a length L3 of the placement region 40A of the medium placement stage 40 in the right-left direction Y.

Examples of the medium 45 to be placed on the medium placement stage 40 include a “display base material”. The display base material is paper having a special function. The display base material includes a base, a colored layer disposed on the base, and a shield layer disposed on the colored layer. Adhesion of the curing liquid to the shield layer causes the shield layer to pass light therethrough. Removal of the curing liquid from the shield layer causes the shield layer to block light. The surface of the shield layer is provided with microscopic asperities. Thus, when no curing liquid adheres to the shield layer, light is reflected off the shield layer, so that the color of the colored layer is visually unidentifiable. When the curing liquid adheres to the shield layer, light passes through the shield layer, so that the color of the colored layer is visually identifiable. Accordingly, printing a test pattern by discharging the curing liquid onto the display base material from nozzles 54 of the line heads 52 makes it possible to visually identify the color of the colored layer so as to enable visual identification of the test pattern. Removal of the curing liquid adhering to the shield layer (e.g., removal of the curing liquid caused by drying of the curing liquid) makes it impossible to visually identify the color of the colored layer because light is reflected off the shield layer again. Thus, the curing liquid adhering to the display base material is removable by drying, for example. This enables repeated use of the display base material.

As illustrated in FIG. 1, the holder 30 includes a heater 42 to heat the medium 45. The heater 42 is disposed under the placement region 40A. The heater 42 may be disposed at any other location. Heating the medium 45 by the heater 42 promotes drying of the curing liquid adhering to the medium 45.

The maintenance device 70 performs maintenance of the nozzles 54 of the line heads 52. The maintenance device 70 is disposed on a portion of the holder 30 rearward of the printing table 34. In other words, the maintenance device 70 is disposed on a portion of the holder 30 upstream of the printing table 34 in the scanning direction X. The maintenance device 70 is parallel or substantially parallel to the printing table 34 in the right-left direction Y. Although the maintenance device 70 and the printing table 34 are parallel or substantially parallel to each other in the right-left direction Y, the left end of the maintenance device 70 does not necessarily have to be in perfect parallel alignment (i.e., located along a same imaginary line extending in the direction X) with the left end of the printing table 34 in the right-left direction Y, and the right end of the maintenance device 70 does not necessarily have to be in perfect parallel alignment (i.e., located along a same imaginary line extending in the direction X) with the right end of the printing table 34 in the right-left direction Y. A large portion of the maintenance device 70 (e.g., a portion of the maintenance device along 80 percent or more of its length in the right-left direction Y) may be parallel or substantially parallel to a large portion of the printing table 34 (e.g., a portion of the printing table 34 along about 80 percent or more of its length in the right-left direction Y) in the right-left direction Y. The maintenance device 70 is disposed below the line heads 52. The maintenance device 70 includes a flushing stage 72, a wiper 74, and a cap 76. The flushing stage 72, the wiper 74, and the cap 76 are disposed in this order from the downstream side to the upstream side in the scanning direction X. The wiper 74 is disposed rearward of the flushing stage 72. The wiper 74 is disposed forward of the cap 76. The wiper 74 is disposed between the flushing stage 72 and the cap 76 in the scanning direction X.

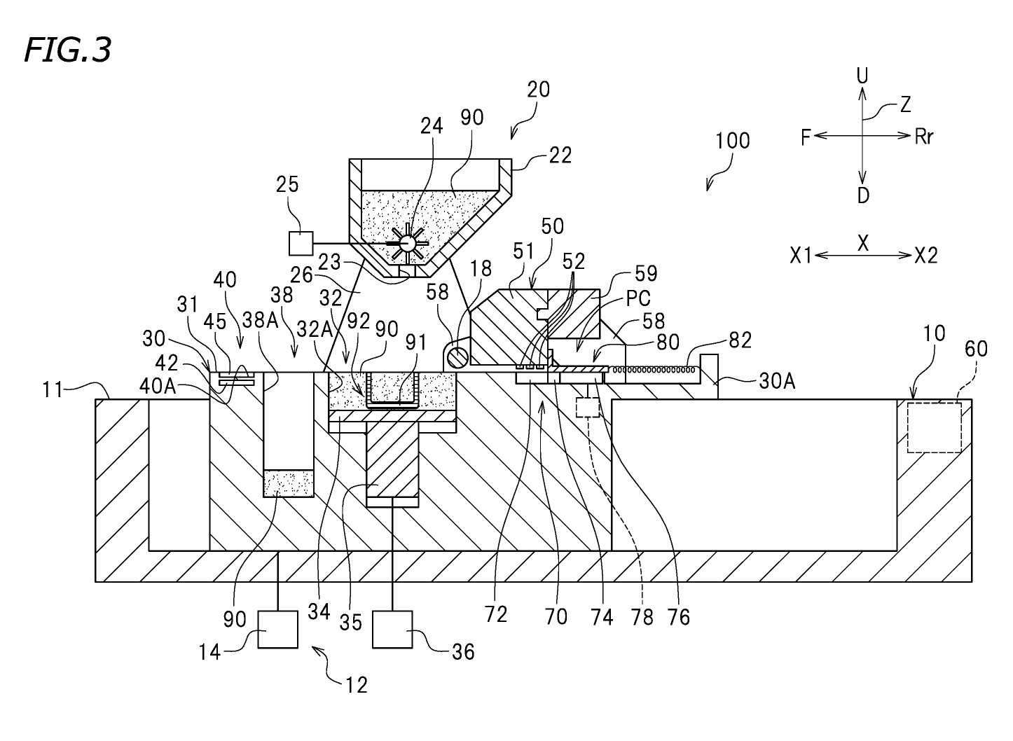

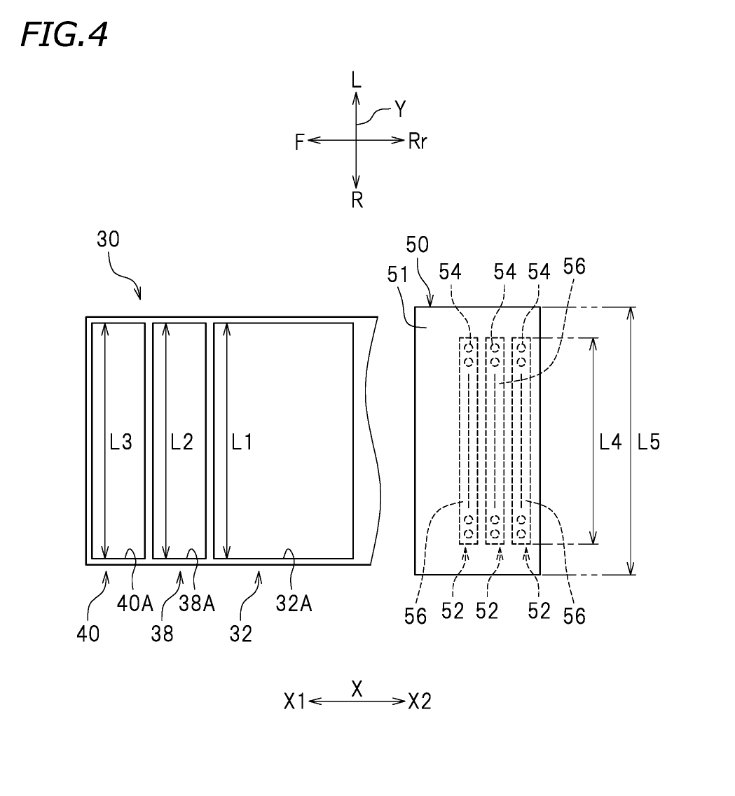

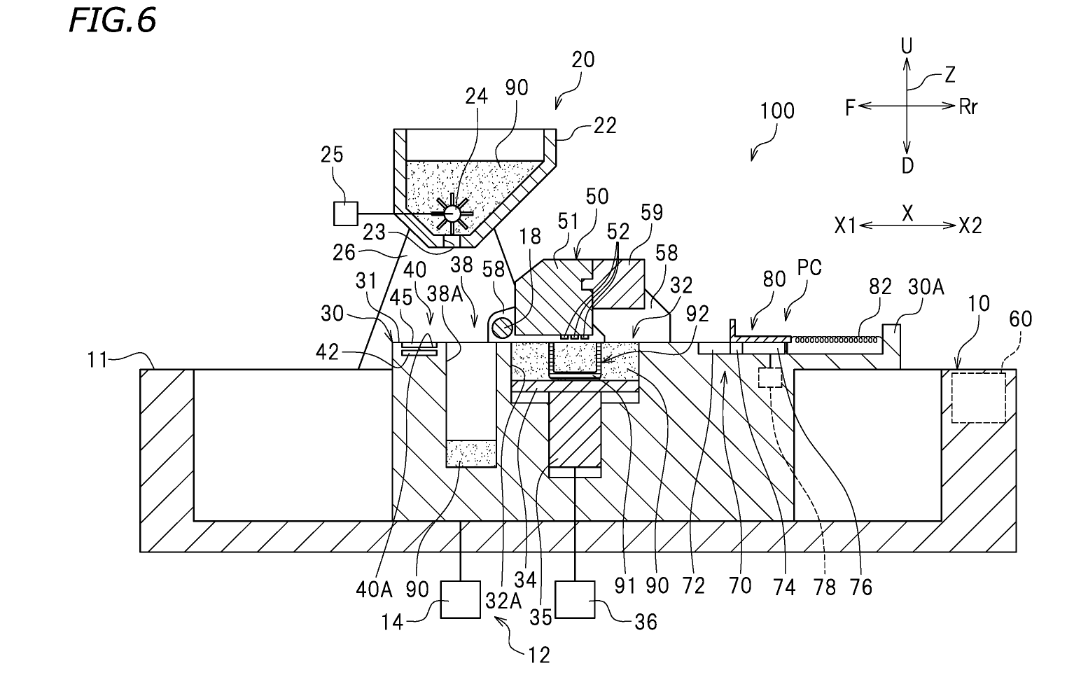

The curing liquid is discharged onto the flushing stage 72 from the nozzles 54 (see FIG. 4). The flushing stage 72 is provided with a porous body to absorb the curing liquid discharged. A length of the flushing stage 72 in the right-left direction Y is equal to or longer than a length L4 of each line head 52 in the right-left direction Y (see FIG. 4). A flushing process involves discharging a predetermined amount of the curing liquid onto the flushing stage 72 from the nozzles 54. In one example, the holder 30 is moved in the direction X2 so as to form one cured layer 91 (see FIG. 6), and then the holder 30 is moved in the direction X1 so as to perform the flushing process (see FIG. 3). In other words, the flushing process is performed when the line heads 52 are located over the flushing stage 72. The frequency of performing the flushing process is not limited to any particular frequency. The flushing process may be performed each time one cured layer 91 is formed or may be performed each time the cured layers 91 are continuously formed.

The wiper 74 is able to wipe a nozzle surface 56 (see FIG. 4) of each line head 52. The wiper 74 is able to come into contact with the nozzle surfaces 56 when the line heads 52 pass over the wiper 74. The wiper 74 is a plate member made of rubber, for example. A length of the wiper 74 in the right-left direction Y is equal to or longer than a length of each line head 52 between the leftmost nozzle 54 and the rightmost nozzle 54.

The cap 76 prevents clogging of the nozzles 54 caused by cured ink adhering to the nozzle surfaces 56 of the line heads 52. During printing standby (i.e., when no three-dimensional object 92 is being printed), the cap 76 is attached to the line heads 52 from below such that the nozzle surfaces 56 are covered with the cap 76 (see FIG. 1). In other words, when the head unit 50 is located at a home position HP, the cap 76 is attached to the line heads 52. As used herein, the term “home position HP” refers to a position where the head unit 50 is put on standby during printing standby (i.e., when no three-dimensional object 92 is being printed or no test pattern printing is being performed). The cap 76 is movable in the up-down direction Z by a cap conveyor 78. Attaching the cap 76 to the line heads 52 defines an enclosed space between the cap 76 and the nozzle surfaces 56. Before the start of printing, the cap conveyor 78 moves the cap 76 downward so as to move the cap 76 away from the nozzle surfaces 56. This detaches the cap 76 from the line heads 52.

The maintenance device 70 includes a suction pump (not illustrated) to suck a fluid (e.g., the curing liquid) in the enclosed space, with the cap 76 attached to the line heads 52. This suction reduces the pressure inside the enclosed space such that the pressure inside the enclosed space is lower than atmospheric pressure. As a result, the suction pump sucks the curing liquid in the nozzles 54 of the line heads 52. The fluid sucked from the enclosed space by the suction pump is stored in a waste fluid tank (not illustrated). The curing liquid is sucked in this manner in order to eliminate defective discharge of the curing liquid from the nozzles 54 and preclude clogging of the nozzles 54 of the line heads 52.

The maintenance device 70 includes: a cover 80 that covers the wiper 74 and the cap 76; and urging members 82 to urge the cover 80 toward a case 51 (which will be described below) of the head unit 50. The cover 80 is disposed above the wiper 74 and the cap 76 except when the cap 76 is located at a capping position where the cap 76 is attached to the line heads 52. The cover 80 covers the wiper 74 and the cap 76 at least when the curing liquid is discharged onto the powder material 90 from the nozzles 54 of the line heads 52. The cover 80 is located over the wiper 74 and the cap 76 at least when the curing liquid is discharged onto the powder material 90 from the nozzles 54 of the line heads 52. The cover 80 overlaps with the wiper 74 and the cap 76 in the plan view at least when the curing liquid is discharged onto the powder material 90 from the nozzles 54 of the line heads 52. In the present preferred embodiment, the cover 80 covers the wiper 74 and the cap 76 when the head unit 50 is located at a position different from the home position HP. In the present preferred embodiment, the cover 80 covers only the cap 76 when the line heads 52 are located over the wiper 74. The cover 80 covers the wiper 74 and the cap 76 when the line heads 52 are located over the flushing stage 72 (see FIG. 3).

Each urging member 82 urges the cover 80 toward the case 51. Each urging member 82 urges the cover 80 forward. In one example, each urging member 82 is a compression spring. Each urging member 82 is provided on a support 30A of the holder 30. The support 30A is disposed rearward of the maintenance device 70. Pressing the cover 80 against the case 51 of the head unit 50 (i.e., movement of the holder 30 in the direction X1 in FIG. 3) moves the cover 80 from a closing position PC (see FIG. 3) to an opening position PO (see FIG. 1). With the cover 80 located at the closing position PC, the wiper 74 and the cap 76 are covered with the cover 80. With the cover 80 located at the opening position PO, at least one of the wiper 74 and the cap 76 is exposed. When the case 51 is not pressed against the cover 80, the urging members 82 urge the cover 80 toward the case 51. This moves the cover 80 to the closing position PC where the cover 80 covers the wiper 74 and the cap 76.

As illustrated in FIG. 1, the conveyor 12 is a device to move the holder 30 relative to the head unit 50, the powder feeder 20, and the spreading roller 18 in the scanning direction X (i.e., in the onward direction X1 and the backward direction X2). In the present preferred embodiment, the conveyor 12 moves the holder 30 in the body 10 in the scanning direction X so as to move the holder 30 relative to the head unit 50, the powder feeder 20, and the spreading roller 18 in the scanning direction X. In the present preferred embodiment, the conveyor 12 includes a pair of guide rails 13 (see FIG. 2), and a first drive motor 14.

As illustrated in FIG. 1, the guide rails 13 guide movement of the holder 30 in the scanning direction X. The guide rails 13 are provided in the body 10. The guide rails 13 extend in the scanning direction X. The holder 30 is in slidable engagement with the guide rails 13. The location of each guide rail 13 is not limited to any particular location. The number of guide rails 13 is not limited to any particular number. The first drive motor 14 is connected to the holder 30. The first drive motor 14 is electrically connected to the controller 60. Rotating the first drive motor 14 moves the holder 30 along the guide rails 13 in the scanning direction X.

As illustrated in FIG. 1, the powder feeder 20 feeds the powder material 90 into the printing tank 32 of the holder 30. The powder feeder 20 is provided above the holder 30. The powder feeder 20 is disposed forward of the line heads 52. The powder feeder 20 is disposed downstream of the line heads 52 in the scanning direction X. The powder feeder 20 includes a storage tank 22 and a feeder 24.

The storage tank 22 stores the powder material 90. The storage tank 22 is disposed above the holder 30. As illustrated in FIG. 2, the body 10 includes an upper surface 11 on which two upwardly extending supports 26 are provided. The supports 26 are parallel or substantially parallel to each other in the scanning direction X. The storage tank 22 is supported by the supports 26. The storage tank 22 is open upward. A length of the storage tank 22 in the front-rear direction X decreases as the storage tank 22 extends downward.

As illustrated in FIG. 1, the bottom surface of the storage tank 22 is provided with a feed port 23. The powder material 90 in the storage tank 22 is fed onto the printing table in the printing tank 32 through the feed port 23. In the present preferred embodiment, the feed port 23 preferably has a rectangular or substantially shape. Alternatively, the feed port 23 may have any other shape.

As illustrated in FIG. 1, the feeder 24 is a device to feed the powder material 90, stored in the storage tank 22, into the printing space 32A of the printing tank 32. The feeder 24 is not limited to any particular configuration. In one example, the feeder 24 is a rotary valve. The feeder 24 is disposed in the storage tank 22. The feeder 24 is disposed in the storage tank 22 such that the feeder 24 is buried in the powder material 90 in the storage tank 22. The feeder 24 is connected with a second drive motor 25. The second drive motor 25 is electrically connected to the controller 60. When the printing tank 32 is located under the feed port 23 of the storage tank 22, the second drive motor 25 is driven so as to rotate the feeder 24. The rotation of the feeder 24 stirs the powder material 90 in the storage tank 22, and feeds some of the powder material 90 into the printing space 32A of the printing tank 32 through the feed port 23.

As illustrated in FIG. 1, the powder material 90 fed from the powder feeder 20 is spread through the printing space 32A by the spreading roller 18. The spreading roller 18 flattens the surface of the powder material 90 fed onto the printing table 34. This forms a powder layer having a uniform thickness. The spreading roller 18 is disposed above the body 10. The spreading roller 18 is disposed between the feed port 23 of the storage tank and the line heads 52 in the scanning direction X. The spreading roller 18 is disposed rearward of the feed port 23. The spreading roller 18 is disposed forward of the line heads 52. The spreading roller 18 has an elongated cylindrical shape. The spreading roller 18 is disposed such that its axis extends in the right-left direction Y. A length of the spreading roller 18 in the right-left direction Y is longer than the length L1 of the printing space 32A of the printing tank 32 in the right-left direction Y. The lower end of the spreading roller 18 is disposed slightly above the holder 30 such that a predetermined clearance (or gap) is created between the lower end of the spreading roller and the upper surface 31 of the holder 30. The spreading roller 18 is rotatably supported by a pair of supports 58 provided on the upper surface 11 of the body 10. The supports 58 extend upward from the upper surface 11. The supports 58 are parallel or substantially parallel to each other in the scanning direction X. Driving a motor (not illustrated) electrically connected to the controller 60 rotates the spreading roller 18 in a forward direction or a reverse direction.

As illustrated in FIG. 4, the head unit 50 according to the present preferred embodiment includes the line heads 52 and the case 51 holding the line heads 52. In the present preferred embodiment, the number of line heads 52 is three, and the three line heads 52 are disposed side by side in the scanning direction X. Each line head 52 is a device from which the curing liquid to bind particles of the powder material 90 is discharged onto the powder material 90 placed on the printing table 34. The head unit 50 is supported by the body 10 such that each line head 52 is located above the holder 30. The head unit 50 is secured to a cross member 59 extending between the supports 58 provided on the upper surface 11 of the body 10. This makes the line heads 52 immovable in the right-left direction Y. The cross member 59 extends in the right-left direction Y so as to connect the supports 58 to each other. A length L5 of the case 51 of the head unit 50 in the right-left direction Y is longer than the length L1 of the printing space 32A of the printing tank 32 in the right-left direction Y. The length L4 of each line head 52 in the right-left direction Y is shorter than the length L1 of the printing space 32A of the printing tank 32 in the right-left direction Y. Each line head 52 may discharge the curing liquid in any mode. In one example, each line head 52 may discharge the curing liquid in an inkjet mode. Each line head 52 includes: the nozzles 54 from which the curing liquid is to be discharged; and the nozzle surface 56 on which the nozzles 54 are provided. The nozzles 54 of each line head 52 are disposed in a straight line in the right-left direction Y. The nozzle surface 56 of each line head 52 is located below the lower surface of the case 51. Each line head 52 is electrically connected to the controller 60. The controller 60 controls discharge of the curing liquid from the nozzles 54 of each line head 52.

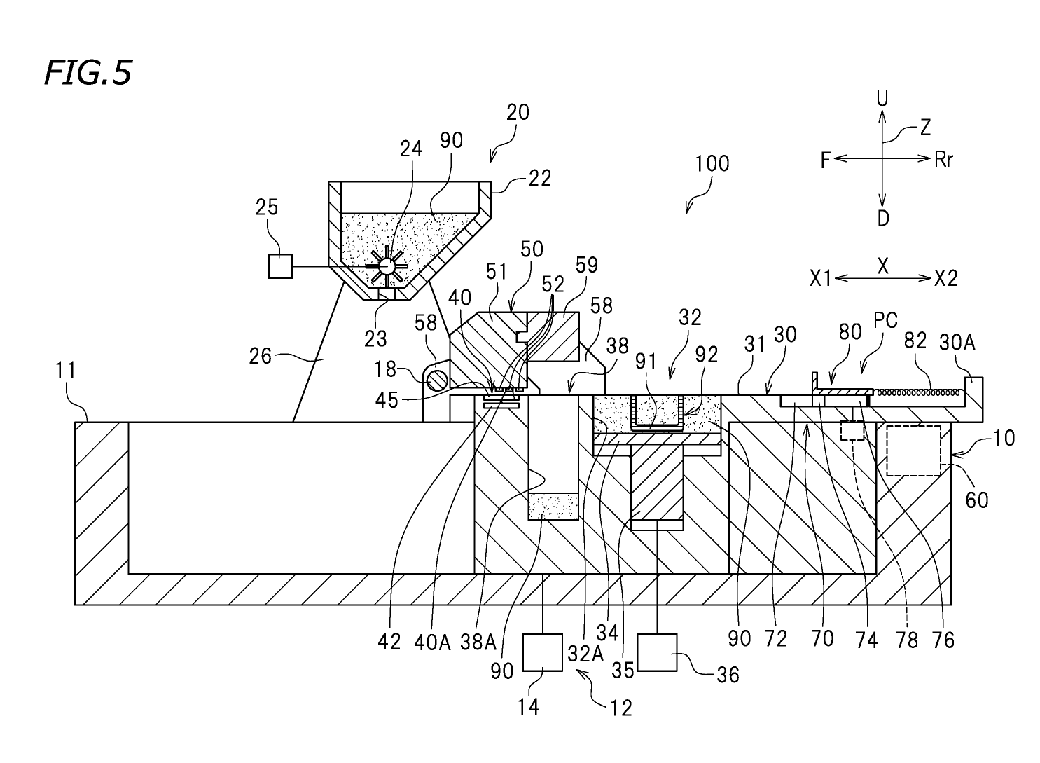

As illustrated in FIG. 1, the holder 30 of the three-dimensional printing apparatus 100 is located at a foremost position in the body 10 when the head unit 50 is located at the home position HP. In one example, before the three-dimensional printing apparatus 100 starts printing the three-dimensional object 92, the holder 30 is moved in the direction X2 in FIG. 1 such that the nozzles 54 (see FIG. 4) of the line heads 52 are located over the medium placement stage 40 as illustrated in FIG. 5. The controller 60 effects control such that a test pattern stored in advance in the controller 60 is printed on the medium 45 placed on the medium placement stage 40. After the test pattern is printed on the medium 45, the holder 30 is moved in the direction X1 in FIG. 5, so that the head unit 50 is returned to the home position HP (see FIG. 1). The operator checks the medium 45, on which the test pattern has been printed, so as to determine, for example, whether maintenance of the line head(s) 52 is necessary.

Upon start of printing, the holder 30 is moved in the direction X2 in FIG. 1 until the holder 30 reaches its position illustrated in FIG. 3, for example. The holder 30 is moved further in the direction X2 in FIG. 3 until the nozzles 54 of the line heads 52 are located over the printing tank 32 (see FIG. 6). In this state, the curing liquid is discharged from the nozzles 54 so as to form one cured layer 91. The holder 30 is subsequently moved in the direction X1 in FIG. 6 until the nozzles 54 of the line heads 52 are located over the flushing stage 72 (see FIG. 3). In this state, the flushing process is performed. After the flushing process is performed, the raising and lowering device 36 lowers the printing table 34 by a distance corresponding to the thickness of the cured layer 91 just formed. Then, the powder material 90 is fed through the feed port 23 of the powder feeder 20 such that the amount of powder material 90 fed is enough for formation of one cured layer 91. The holder 30 is subsequently moved in the direction X2 in FIG. 3, so that the spreading roller 18 spreads the powder material 90 through the printing tank 32 (see FIG. 6). During spreading of the powder material 90, an excess portion of the powder material 90 that is not stored in the printing tank 32 is collected into the excess powder storing tank 38. The holder 30 is then moved in the direction X1 in FIG. 6 until the nozzles 54 of the line heads 52 are located over the flushing stage 72 (see FIG. 3). The holder 30 is subsequently moved in the direction X2 in FIG. 3 until the nozzles 54 of the line heads 52 are located over the printing tank 32 (see FIG. 6). In this state, the curing liquid is discharged from the nozzles 54 so as to form the next cured layer 91. The above steps are repeatedly performed so as to sequentially stack the cured layers 91. Consequently, the three-dimensional object 92 having a desired shape is printed.

For example, when the three-dimensional printing apparatus 100 has finished printing the three-dimensional object 92, the holder 30 is moved in the direction X1 in FIG. 6 until the holder 30 reaches the position illustrated in FIG. 3. The holder 30 is then moved further in the direction X1 in FIG. 3 so as to wipe the nozzle surface 56 of each line head 52 with the wiper 74. After the nozzle surface 56 of each line head 52 is wiped, the cap 76 is attached to the line heads 52, and the curing liquid in the nozzles 54 is sucked (see FIG. 1). This prevents clogging of the nozzles 54 of the line heads 52.

As described above, the medium placement stage 40 of the three-dimensional printing apparatus 100 according to the present preferred embodiment is disposed on the holder 30. More specifically, the medium placement stage 40 is disposed downstream of the printing table 34 in the scanning direction X. The medium placement stage 40 is parallel or substantially parallel to the printing table 34 in the right-left direction Y. The nozzles 54 of each line head 52 are disposed in a straight line in the right-left direction Y, so that the length of each line head 52 in the right-left direction Y is relatively long. Thus, if the medium placement stage 40 is disposed laterally of the printing table 34 (i.e., if the medium placement stage 40 and the printing table 34 are parallel or substantially parallel to each other in the scanning direction X), the length of the three-dimensional printing apparatus 100 in the right-left direction Y will be considerably long. This makes it necessary to provide a device to move the line heads 52 in the right-left direction Y, resulting in complicated structure of the three-dimensional printing apparatus 100. In the present preferred embodiment, however, the medium placement stage 40 is parallel or substantially parallel to the printing table 34 in the right-left direction Y, so that the length of the three-dimensional printing apparatus 100 increases only slightly in the scanning direction X. In the present preferred embodiment, the line heads 52 are required to be moved relative to the holder 30 only in the scanning direction X. Thus, the three-dimensional printing apparatus 100 according to the present preferred embodiment enables the medium placement stage 40 to be disposed compactly. Consequently, the three-dimensional printing apparatus 100 does not increase in size.

The medium 45 used in the three-dimensional printing apparatus 100 according to the present preferred embodiment is a display base material including a colored layer and a shield layer disposed on the colored layer. Adhesion of the curing liquid to the shield layer causes the shield layer to pass light therethrough. Removal of the curing liquid from the shield layer causes the shield layer to block light. Thus, for example, evaporating the curing liquid from the shield layer enables repeated use of a single display base material. Consequently, the medium 45 on which a test pattern is to be printed is easily stored in reusable condition.

The holder 30 of the three-dimensional printing apparatus 100 according to the present preferred embodiment includes the heater 42 to heat the medium 45. This promotes evaporation of the curing liquid adhering to the medium 45, resulting in rapid removal of the curing liquid from the shield layer. For example, suppose that test patterns are to be printed continuously. In such a case, the test patterns will be printed in a shorter time than when no heater 42 is provided.

The excess powder storing tank 38 of the three-dimensional printing apparatus 100 according to the present preferred embodiment is disposed in a portion of the holder 30 located between the printing tank 32 and the medium placement stage 40 in the scanning direction X. Thus, an excess portion of the powder material 90 that is not stored in the printing space 32A is collected into the excess powder storing tank 38. This keeps the powder material 90 from scattering over the medium placement stage 40 and prevents trouble during test pattern printing.

The maintenance device 70 of the three-dimensional printing apparatus 100 according to the present preferred embodiment is disposed on the holder 30. More specifically, the maintenance device 70 is disposed upstream of the printing table in the scanning direction X. The maintenance device 70 is parallel or substantially parallel to the printing table 34 in the right-left direction Y. The nozzles 54 of each line head 52 are disposed in a straight line in the right-left direction Y, so that the length of each line head 52 in the right-left direction Y is relatively long. Thus, if the maintenance device 70 is disposed laterally of the printing table 34 (i.e., if the maintenance device 70 and the printing table 34 are parallel or substantially parallel to each other in the scanning direction X), the length of the three-dimensional printing apparatus 100 in the right-left direction Y will be considerably long. This makes it necessary to provide a device to move the line heads 52 in the right-left direction Y, resulting in a complicated structure of the three-dimensional printing apparatus 100. In the present preferred embodiment, however, the maintenance device 70 is parallel or substantially parallel to the printing table 34 in the right-left direction Y, so that the length of the three-dimensional printing apparatus 100 increases only slightly in the scanning direction X. In the present preferred embodiment, the line heads 52 are required to be moved relative to the holder 30 only in the scanning direction X. Thus, the three-dimensional printing apparatus 100 according to the present preferred embodiment enables the maintenance device 70 to be disposed compactly. Consequently, the three-dimensional printing apparatus 100 does not increase in size.

The flushing stage 72 of the three-dimensional printing apparatus 100 according to the present preferred embodiment is disposed closer to the printing table 34 than the cap 76 in the scanning direction X. Thus, in the course of printing the three-dimensional object 92, the flushing process involving discharging the curing liquid onto the flushing stage 72 from the nozzles 54 of the line heads 52 is carried out with a simple and minimum movement.

The wiper 74 of the three-dimensional printing apparatus 100 according to the present preferred embodiment is disposed between the flushing stage 72 and the cap 76 in the scanning direction X. Thus, after the flushing process is performed and the nozzle surface 56 of each line head 52 is wiped, the cap 76 is attached to the line heads 52 with a one-way movement. This facilitates control involved in maintenance of the nozzles 54.

The maintenance device 70 of the three-dimensional printing apparatus 100 according to the present preferred embodiment includes the cover 80 to cover the wiper 74 and the cap 76 at least when the curing liquid is discharged onto the powder material 90 from the nozzles 54. Discharging the curing liquid onto the powder material 90 from the nozzles 54 may cause the powder material 90 to swirl up in the air. Thus, if no cover 80 is provided, the powder material 90 swirling up in the air may adhere to the wiper 74 and the cap 76. In the present preferred embodiment, however, the cover 80 covers the wiper 74 and the cap 76 when the curing liquid is discharged onto the powder material 90 from the nozzles 54. This prevents the powder material 90 from adhering to the wiper 74 and the cap 76.

The cover 80 of the three-dimensional printing apparatus 100 according to the present preferred embodiment is pressed against the case 51. This moves the cover 80 from the closing position PC where the wiper 74 and the cap 76 are covered with the cover 80 to the opening position PO where at least one of the wiper 74 and the cap 76 is exposed. Thus, with a simple structure, the present preferred embodiment enables the cover 80 to move between the closing position PC and the opening position PO in accordance with the movement of the holder 30 relative to the case 51 of the head unit 50.

Although the preferred embodiments of the present invention have been described thus far, the preferred embodiments described above are only illustrative. The present invention may be embodied in various other forms.

In the foregoing preferred embodiments, the maintenance device 70 is disposed rearward of the printing tank 32, and the medium placement stage 40 is disposed forward of the printing tank 32. The present invention, however, is not limited to this arrangement. In one example, the maintenance device 70 may be disposed forward of the printing tank 32, and the medium placement stage 40 may be disposed rearward of the printing tank 32. The three-dimensional printing apparatus 100 may include either one of the maintenance device 70 and the medium placement stage 40.

In the foregoing preferred embodiments, the holder 30 is moved in the scanning direction X relative to the powder feeder 20, the spreading roller 18, and the head unit 50 secured to the body 10. The present invention, however, is not limited to this arrangement. In one example, the holder 30 may be secured to the body 10, and the powder feeder 20, the spreading roller 18, and the head unit 50 may be moved in the scanning direction X relative to the holder 30.

In the foregoing preferred embodiments, the cover 80 covers the wiper 74 and the cap 76. The cover 80, however, is not limited to this configuration. In one example, the cover 80 may cover not only the wiper 74 and the cap 76 but also the flushing stage 72 when the curing liquid is discharged onto the powder material 90 from the nozzles 54.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms. This disclosure should be regarded as providing preferred embodiments of the principle of the present invention. These preferred embodiments are provided with the understanding that they are not intended to limit the present invention to the preferred embodiments described in the specification and/or shown in the drawings. The present invention is not limited to the preferred embodiments described herein. The present invention encompasses any of preferred embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the preferred embodiments described in this specification or referred to during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A three-dimensional printing apparatus to print a three-dimensional object by sequentially stacking cured layers each defined by a cured powder material, the three-dimensional printing apparatus comprising:
a holder to hold the three-dimensional object being printed;
a printing tank disposed in the holder, the printing tank including a printing space in which the powder material is to be held;
a printing table on which the powder material is to be placed, the printing table being disposed in the printing space of the printing tank;
a line head including:
a plurality of nozzles disposed in a straight line in a first direction to discharge a curing liquid onto the powder material placed on the printing table; and
a nozzle surface provided with the nozzles;
a conveyor to move one of the holder and the line head relative to the other one of the holder and the line head in a second direction perpendicular or substantially perpendicular to the first direction; and
a medium placement stage on which a medium to undergo test pattern printing effected by the line head is to be placed, the medium placement stage being disposed on a portion of the holder located on one side in the second direction relative to the printing table, the medium placement stage being parallel or substantially parallel to the printing table in the first direction.

2. The three-dimensional printing apparatus according to claim 1, wherein
the medium is a display base material including a colored layer and a shield layer disposed on the colored layer;
the shield layer allows light to pass therethrough when the curing liquid adheres to the shield layer; and
the shield layer blocks light when the curing liquid is removed from the shield layer.

3. The three-dimensional printing apparatus according to claim 2, wherein the holder includes a heater to heat the medium.

4. The three-dimensional printing apparatus according to claim 1, further comprising:
a storage tank disposed on the one side in the second direction relative to the line head, the storage tank storing the powder material, the storage tank including a feed port through which the powder material is to be fed into the printing space;
a spreader disposed between the feed port and the line head in the second direction to cause the powder material fed through the feed port to spread through the printing space; and
an excess powder storing tank disposed in a portion of the holder between the printing tank and the medium placement stage in the second direction to collect an excess portion of the powder material that is not stored in the printing space.

5. A three-dimensional printing apparatus to print a three-dimensional object by sequentially stacking cured layers each defined by a cured powder material, the three-dimensional printing apparatus comprising:
a holder to hold the three-dimensional object being printed;
a printing tank disposed in the holder, the printing tank including a printing space in which the powder material is to be held;
a printing table on which the powder material is to be placed, the printing table being disposed in the printing space of the printing tank;
a line head including:
a plurality of nozzles disposed in a straight line in a first direction to discharge a curing liquid onto the powder material placed on the printing table; and
a nozzle surface provided with the nozzles;
a conveyor to move one of the holder and the line head relative to the other one of the holder and the line head in a second direction perpendicular or substantially perpendicular to the first direction; and
a maintainer to perform maintenance of the nozzles, the maintainer being disposed on a portion of the holder located on one side in the second direction relative to the printing table, the maintainer being parallel or substantially parallel to the printing table in the first direction.

6. The three-dimensional printing apparatus according to claim 5, wherein the maintainer includes:
a flushing stage onto which the curing liquid is to be discharged from the nozzles; and
a cap to be attached to the line head so as to cover the nozzle surface; and
the flushing stage is closer to the printing table than the cap in the second direction.

7. The three-dimensional printing apparatus according to claim 6, wherein
the maintainer includes a wiper to wipe the nozzle surface; and
the wiper is disposed between the flushing stage and the cap in the second direction.

8. The three-dimensional printing apparatus according to claim 7, wherein the maintainer includes a cover to cover the wiper and the cap at least when the curing liquid is discharged onto the powder material from the nozzles.

9. The three-dimensional printing apparatus according to claim 8, further comprising a case holding the line head, wherein
the maintainer includes a pusher to urge the cover toward the case; and
pressing the cover against the case moves the cover from a closing position where the wiper and the cap are covered with the cover to an opening position where at least one of the wiper and the cap is exposed.
